(19) United States
(12) Patent Application Publication
(10) Pub. No.: US 2016/0189498 A1
(43) Pub. Date: Jun. 30, 2016

(54) Internet of things locker

(71) Applicant: EXILANT Technologies Pvt. Ltd., Bangalore (IN)

(72) Inventors: Vishnu Sharma, Bhubaneswar (IN); Madhav Sivadas, Singapore (SG)

(73) Assignee: EXILANT Technologies Pvt. Ltd., Bangalore (IN)

(21) Appl. No.: 14/757,967

(22) Filed: Dec. 24, 2015

(30) Foreign Application Priority Data
Dec. 24, 2014 (IN) 6556/CHE/2014

(51) Int. Cl. G08B 13/16; G08B 25/00; H04L 29/08

(52) U.S. Cl. CPC G08B 13/1654; H04L 67/12; G08B 25/006

(57) ABSTRACT

The present invention relates to a re-usable internet based locking device that uses electronic keys (either single or a combination to be distributed to multiple parties) for opening and closing the locking device. It enables the institutions to offer highly secure, vault-grade locking device to their user in public places. These kiosks have security and surveillance levels that match bank ATMs. In addition, an optional visual tracking system allows the users to view the contents of their locking device, thus providing additional comfort regarding safety of their valuables in the locking device. A peripheral surveillance system with internal power backup and wireless internet connectivity is provided for alerting the central monitoring station if any distress is found in and around the kiosk.

This patent application claims priority benefit of Indian patent application 6556/CHE/2014, filed on Dec. 24, 2014.

### FIELD OF THE INVENTION

The present invention generally relates to secure, vault-grade electronic key based locking device, and more particularly to re-usable internet based electronic locking device that use electronic keys to safely store and retrieve valuables.

### BACKGROUND OF THE INVENTION

Personal loans collaterized with gold is a very common practice in many countries. A user visits the office of the loan provider, deposits gold and receives a cash loans with a certain interest rate. This process works well when the loan receiver has a plan to pay back the loan. There are situations, where a loan is needed in emergency situations (e.g. hospitalization). In such cases, visiting a loan provider's office could cost dearly, when money is required urgently. Hence, it can makes sense to have a locker kiosk in required places.

Various types of lockers have been used before. For many years, banks maintain deposit boxes which includes a pair of locks in which one is opened by key carried by the user and the other with key retained in the bank. Even though these lockers provide secure protection, they take time in processing the request and they cannot be used immediately to avail oneself of a loan during emergency situations.

Additionally, there are a number of cases, where a locking device is required to safely keep ones belongings for a limited period of time e.g. airports, railway stations, gymnasium lockers, sports complexes. In all these cases, as of today, a key is provided to the user and sometimes, a duplicate key is present with the representative who manages the locker. However, there are risks associated with giving the key either to the user, or to the representative, or to both. Hence, there arises a need to safely protect the valuables while reducing the risk of fraud and theft.

Indeed, a number of different lockers have been designed based on biometric authentication, temporal/spatial authentication, RFID authentication. These identification systems use specific identifiers to map the user of the valuable item. And, portable lockers have also been placed in public places like airports, railway stations etc.

There are lockers designed for personal use that work on electronic key and sometimes send an SMS on unauthorized access.

Despite the foregoing methods and systems, there is still a salient need for a flexible and efficient locking device that provides the user with a highly configurable and modular system that can be readily adapted to a number of different paradigms. The above mentioned systems do not provide means for complete security of the valuables. Also, during emergency situations, loans cannot be easily/readily/competently availed with the help of such systems. Hence, the present invention provides a solution for constant 24×7 remote monitoring of locking device and its contents by authorized personnel via a secure and integrated Internet of Things (IOT) locking device.

### SUMMARY OF THE INVENTION

The objective of the invention is to design a re-usable internet based locking device that utilizes electronic keys for securing valuables.

The present invention conceives an electronic key based locking device that is used for different purposes with different settings. It also provides a mechanism where the locking device as well as its contents is remotely and continuously monitored by authorized personnel. The locking device can be integrated with electronic keys using various different mechanisms (e.g. SMS, Biometric).

In one embodiment of the present invention, the internet based locking device can be used as Gold loan kiosk. An electronic key can be given to the kiosk agent, the user and a remote office of the loan company. A combination of all the three can only open the locking device.

In another embodiment of the present invention, in common areas like airports, railway stations, gymnasium, sports complexes where people congregate mainly, the user can deposit costly artifacts on the airport, acquire an electronic password (key) and can travel to long places. Once they are back, they can open the locking device and retrieve the items, thus providing zero possibility of losing the key.

According to the present invention, these highly secure kiosk are operated in places that have the security level that exceeds bank ATM. Users operate the locking device to store and retrieve the valuables with multi-factor authorization mechanism to ensure that unauthorized access cannot open the locking device. A linkage to the user record system of the institution also ensures the tracking of persons using the facility. Moreover, an optional visual tracking mechanism is provided to allow the users to view the contents of their locking device. A peripheral surveillance system alerts the central monitoring station of the institution, in case if any distress is detected on or around the kiosk.

Further, the design principle involved in the locking device of the present invention is to make a modular hardware which is customized using software to control locker access. The modular hardware remains the same, whereas the software changes depending upon various usages. The hardware design of the locking device includes various parts like motherboard, electronic lock, status display, vibration sensor, door sensor, SD card, buzzer/speaker, and camera.

Thus, the present invention enables the institutions to offer highly secure, vault-grade locking device to their user in public places.

From the foregoing disclosure and the following more detailed description of various embodiments it will be apparent to those skilled in the art that the present invention provides a significant advance in the technology of lockers. Particularly significant in this regard is the potential the invention affords for providing lockers suitable for. Additional features and advantages of various embodiments will be better understood in view of the detailed description provided below.

### BRIEF DESCRIPTION OF THE DRAWINGS

FIG. 1 is schematic of an internet of thinks locker in accordance with one embodiment.

FIG. 2 is a schematic of a side view of the internet of things locker of FIG. 1.

FIG. 3 is a schematic of the main elements of a electronic control board for the internet of things locker of FIG. 1.

It should be understood that the appended drawings are not necessarily to scale, presenting a somewhat simplified representation of various features illustrative of the basic principles of the invention. The specific design features of the internet of things locker as disclosed here, including, for example, the applications which the locker may be used for will be coordinated with one another will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the internet of things locker disclosed here. The following detailed discussion of various alternate features and embodiments will illustrate the general principles of the invention with reference to an internet of things locker especially suited for storage of valuable collateral such as precious metals. Other embodiments suitable for other applications will be apparent to those skilled in the art given the benefit of this disclosure.

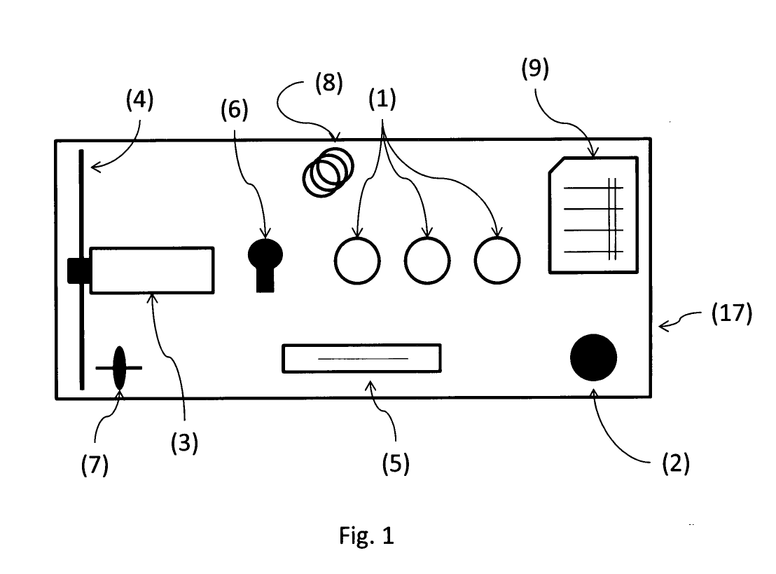

Aspects of the present invention described herein, discloses a re-usable internet based locking device (17) as shown in FIG. 1 that uses electronic keys to secure valuables of a user.

In accordance with the present invention, kiosks are operated in environments and locations that have security and surveillance levels that approximate those of bank ATMs. A user walks into such a location and operates the locking device to store and retrieve the valuables. This kiosk uses secure multi-factor authorization mechanism that prevents unauthorized access from opening the locking device (17) either by mistake or through criminal intent. A linkage may be provided to the institution's user records system to ensure that the persons using the facility are tracked in a similar manner as a bank tracks its user through a know your customer (KYC) process. This ensures that the locking device (17) is not used for illegal purposes. An optional visual tracking mechanism allows the user to view the contents of their locking device (17) which gives them additional comfort regarding the safety of their valuables in the locking device (17). A peripheral surveillance system with internal power backup and wireless internet connectivity is capable of alerting a central monitoring station if any distress (vibration, heat from blow-torch, hammer impact etc.) is detected on or around the kiosk.

Further, in a preferred embodiment, the system merges enterprise applications such as customer relationship management (CRM), loan management systems etc., with Internet of things (IOT) based secured and integrated locking device to provide kiosk type facilities for authorized storage and retrieval of valuables. This enables institutions to provide such services to their users.

FIG. 1 illustrates the locking device (17) box design with all the features and components depicted. The design principle used in the locking device (17) is to make a modular hardware that is customized using software to control locker access. The modular hardware is arranged in any combination to be re-purposed for different needs. The software changes the access and monitoring mechanism for various use cases. The locking device (17) design is like a PC with or without the Operating System (OS). By changing the software, the modular hardware plays different roles. It either works as a super-secure gold deposit requiring multiple key combinations from multiple stakeholders for access or it could be a simple single stakeholder based access.

Referring to the invention in more detail as shown in FIG. 1, the various parts of the locking device are disclosed below.

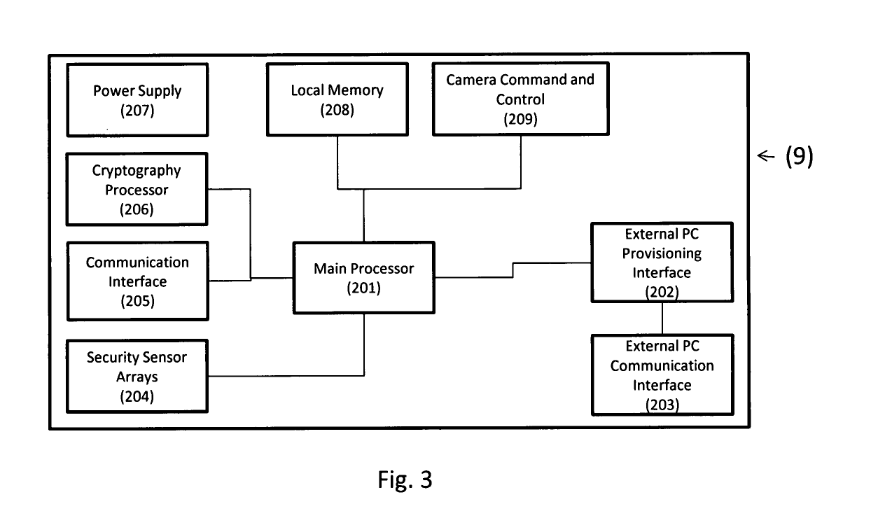

The locking device (17) electronics is controlled by a microcontroller based design (i.e.) motherboard which acts as the CPU. The motherboard is connected with a central command either directly or via an intermediary for information exchange. The communication with the central command happens over any media (e.g. wired, wireless) and using any protocol (e.g. HTTP, CoAP). Thus, each locking device (17) is remotely monitored and controlled from a remote location at all times. Furthermore, each locking device (17) has the capability to create unique digital signature that cannot be copied or cloned. In that way, no one can generate electronic signals to access the locking device (17). More information about the electronic main board 9 and controller is provided in the discussion of FIG. 3 below.

The locking device (17) hardware has a status display (1) at the front panel that displays the status of the locking device (17) at all times. The status display can be an LCD text/graphic display or a simple LED display with color indications. The kind of display is based on the given use case. Moreover, the locking device (17) uses an electromagnetic lock (3) with a channel to support a lock strike to physically lock the safe (17). The electronic lock is opened or closed via software control present in the motherboard. The electronic lock supports both fail-secure and fail-safe design. The locking device may also be provided with a manual key override (6) for maintenance and repair.

Preferably, the locking device (17) hardware is equipped with various sensors to assist in securing the valuables. The locking device can be provided with a vibration sensor to sense any unusual vibration in the locking device (17). If any case is detected, the CPU informs the central command about such suspicious activities on the locking device (17). Also, it has a door sensor to keep track on whether the door is opened or closed. The locking device (17) sends heartbeat messages at regular intervals, and the door status is communicated to the central command.

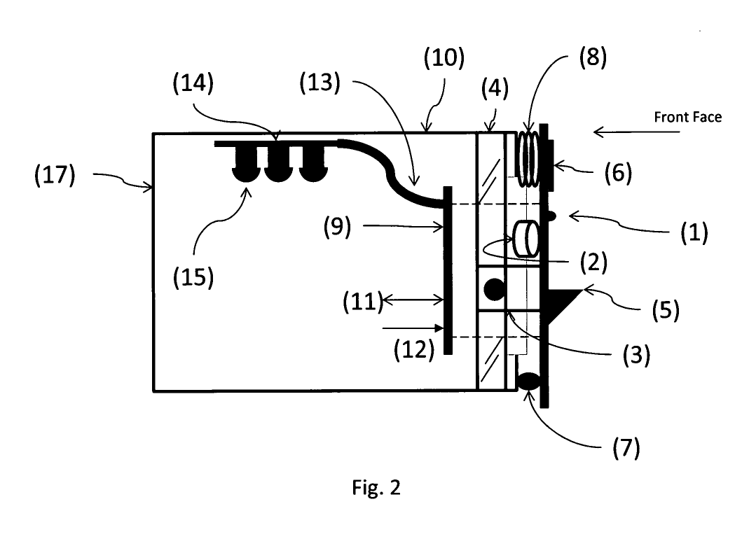

The locking device (17) also includes an audio device to give audio feedback to the agent managing the locking device (17). The audio device can be a simple buzzer (2) type device or could be a complex text-2-speech converter that finally outputs the audio indications via speech. The locking device (17) is equipped with a secure digital (SD) card for caching non-secure information. As shown in FIG. 2, one or more cameras (14) are fitted on the top wall of the locking device (17). The camera (14) captures images of the artifacts stored in the locking device (17) and transmits to the central command or to the identified stakeholders via wireless connection 11. Such a wireless connection advantageously allows for remote monitoring of the storage compartment and whatever valuables may be there. Further, the wireless connection can serve as part of a peripheral surveillance system which can alert a central monitoring station in case of distress detected on or around the locking device, such as tampering, electrical failure, etc. Power inlet 12 provides electricity to operate the various sensors, cameras and locks. A flashlight or other suitable light source 15 may be provided with the camera. This provides visual indication to the stakeholders about the contents of the locking device (17).

The locking device (17) hardware has an outer shell (10) (labeled in FIG. 2) which defines a storage compartment with a storage compartment base to store the valuables, a storage compartment channel, a control board container, a flexible flat ribbon cable (FRC) with an FRC connector socket, screws to open the container from inside, a camera cable (13) to hold the camera (14) in the top ceiling, front panel with a tactile switch/door ajar sensor (7), a spring (8) or other autopush mechanism that pushes out on or biases toward an open position the door or front panel (on the front face, as seen in FIG. 2), a manual override keyhole (6), a notch (5) to be pulled with fingers serving as a manual override device to open the locking device, different colours of LED display and a buzzer (2) or other suitable audio indicator of status. A secure digital card may be provided to cache non-secure information.

Each locking device (17) can be connected to other locking devices and to an embedded PC. This connection can be a “Daisy Chain” mode connection or it can be a simple private intranet connection and further the connection can be of various means. The input to one locking device (17) is obtained from the previous locking device (17) and the output of the present locking device (17) is sent to the next locking device (17). The embedded PC controls a number of lockers and has communication interface units. The communication interface may be wired communication such as Ethernet or wireless communication, in which each communication interface in turn controls a specified number of locking devices (17) on each side. The number of locking devices (17) and their communication interface units vary depending upon the mode of connection used (i.e. “Daisy chain” mode or private intranet type connection etc. During opening of locking device (17), a considerable amount of current is needed. Every locking device (17) is provisioned with a security chip before its installation. During provisioning, a new security chip is installed and the older one is destroyed. Hence, the security chip is not hard-soldered and must sit on a breakout so that the security chip can be replaced easily.

The front panel is housed only with sensors, actuators and indicators. The front panel is housed inside the container which is located behind the Storage compartment face and controlled by the controller board which is located at the back panel of the Storage compartment. Front panel is connected with the back panel via FRC cable. The front panel also may be provided with a door ajar tactile switch/sensor (7) which is located between the frame and the front face and a buzzer (2)/speaker to alert a central monitoring station.

Thus the present invention provides a low-cost design that has maximum effective re-usability. The modular hardware is adopted for different scenarios by simply changing the software. The locking device (17) has multiple safeguard features instead of a set of physical keys. The locking device may advantageously also be integrated with different kinds of key mechanism like, for example, SMS and fingerprint based authentication. This IOT based locking device (17) can provide remote monitoring and at all times, and the locking device (17) status is available remotely. Multiple locking devices (17) may be stacked together to create a large scale unit. This invention is used in a variety of applications including customizing access mechanism from low security (keeping bags at malls) to very high security (storing gold in hospital kiosks) and from personal home use to banking class use.

FIG. 3 shows an electronic control board in accordance with the embodiment of FIG. 1. Main processor/motherboard/microcontroller 201 is operatively connected to an external PC provisioning interface 202, sensor security arrays 204, a communications interface 205, a cryptography processor 206, local memory 208 and a camera command and control 209 for camera 14. The external PC provisioning interface is operatively connected to an external PC via an external PC communication interface 203. The software control from the motherboard sends signals to the various devices, such as to the electronic lock to releasably lock the safe or display or indicate status.

From the foregoing disclosure and detailed description of certain embodiments, it will be apparent that various modifications, additions and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A locking device using electronic keys for providing authorized storage and retrieval of valuables, comprising, in combination:
a motherboard for commanding and controlling the status of connected peripherals in the locking device;
an outer shell defining a storage compartment to hold the valuables; and
a vibration sensor to sense unusual vibration in said locking device, wherein said sensor informs the CPU about a suspicious activity on the locking device;
a door sensor to sense whether the door is opened or closed, wherein said door sensor status communicates to a central command;
an electronic lock to releasably lock the safe wherein said lock is operated by a software control from the motherboard; and
a camera to capture images of the storage compartment to provide visual indication.

2. The locking device of claim 1, wherein a front panel is electrically connected to a back panel.

3. The locking device of claim 1, further comprising a wireless connection allowing for remote monitoring of the storage compartment.

4. The locking device of claim 1, further comprising a peripheral surveillance system to alert a central monitoring station in case of distress detected on or around the locking device.

5. The locking device of claim 1 further comprising a flexible FRC cable which to extends and contracts as the storage compartment is opened and closed.

6. The locking device of claim 1 further comprising a status display to display a status of the locking device;
an audio device to output audio feedback;
a manual override device to open the locking device;
a spring to bias a front panel towards an open position; and
a door ajar sensor.

7. The locking device of claim 1 wherein the camera is fitted to a camera cable attached to the outer shell.

8. The locking device of claim 1 further comprising an FRC connector socket to connect a FRC cable and a secure digital card to cache non-secure information.
